(19) United States
(12) Patent Application Publication
(10) Pub. No.: US 2006/0180154 A1
(43) Pub. Date: Aug. 17, 2006

(54) Apparatus for attaching a hydration device to a full face helmet

(76) Inventor: John T. Stone, Port St. Lucie, FL (US)

Correspondence Address: MCHALE & SLAVIN, P.A., 2855 PGA BLVD, PALM BEACH GARDENS, FL, 33410, US

(21) Appl. No.: 11/056,050

(22) Filed: Feb. 11, 2005

(51) Int. Cl. A62B 18/08; A62B 18/02

(52) U.S. Cl. 128/207.11; 128/205.25; 128/206.12; 128/206.13; 128/206.18; 128/206.21; 128/206.24; 128/206.27

(57) ABSTRACT

An apparatus for attachment to a full-face helmet which positions a hydration tube near the mouth of the wearer. The device includes a flexible member formed from plastic or rubber having a central elongated portion and opposing side arm members. The central elongated portion has an elongated vertical slot therein dimensioned to allow the hydration tube to be slidably disposed therein. Left and right attachment means are respectively disposed on each of the opposing side arm members which secure the opposing arm members to the face protector portion of the helmet so that the flexible member can be suspended inside the helmet and the hydration tube inserted in the slot. The attachment means can be a pair of straps securable to one another. The apparatus can further include an air filter face mask attachable to the flexible T-shaped member.

### FIELD OF THE INVENTION

The present invention relates to sports hydration systems, and more particularly to a device adapted for attachment to a off-road type full face helmet which is constructed and arranged to position a water conduit in close proximity to the user's mouth.

### BACKGROUND OF THE INVENTION

Participants in off-road motorcycling often use portable hydration systems to carry drinking water or other beverages. A popular portable personal hydration system designed for use in endurance sports and other outdoor activities is the type sold under the trademark Camelbak®. The Camelbak® system usually provides a backpack containing a water reservoir and a length of tubing fluidly connected to the reservoir. A bite-valve is fitted on the end of the tube which is operated by the user's lips or teeth. The bite-valve is usually affixed to a clip within reach of the wearer, requiring the wearer to use their hands to detach the bite-valve from the clip, bring it to the mouth for drinking, and then replace it on the clip. If the bite-valve comes out of the clip while riding, it can easily pick up airborne debris.

A problem arises in the practice of sports in which the hands are occupied, such as off-road motorcycle racing, because the hands are not as free to manipulate the tube and reposition it should it become detached from the clip. Thus, a user on a motorcycle must either try to maintain the bite-valve in their mouth at all times, or periodically remove a hand from the handlebars to retrieve the bite-valve from the clip. For an athlete in a competitive sports environment, even this brief interruption is highly undesirable as it may break the rider's concentration.

Since helmets are frequently worn in many sports, there have been attempts in the prior art to combine a hydration delivery system with the helmet in order to position a hydration conduit near the wearer's mouth. Bradley, U.S. Pat. No. 6,283,344, discloses an embodiment of a hands-free hydration delivery system which can be mounted to a helmet. The system includes a length of feed tube coupled to a container worn on the back of the wearer with the distal end of the tubing being coupled to a bite-valve which can be manipulated by a user's mouth. An intermediate portion of the tube is mounted through a tube mounting attached to the lower end of a helmet. The tube mounting can be in the form of a series of retainer loops having their ends attached to the helmet by attachment pads using hook and loop type fastening material. The attachment pads can be retrofitted to a helmet by applying an adhesive to the helmet. Bradley teaches that the tube mounting can be any other suitable type of fastener, such as a molded construction formed with the helmet. One drawback of the Bradley system is that the use of adhesives to apply the attachment pads to the helmet permanently alters the helmet, and if removed, will mar the finish. Also, if the attachment means is integrally formed with the helmet, a specific configuration of helmet is required to use the system. Yet another drawback is that tethering the backpack/container to the helmet creates a cumbersome arrangement.

Davidson, U.S. Pat. No. 4,813,083, discloses a hollow visor capable of being removably attached to a safety helmet of the type used by motorcycle riders. The visor is filled with water and sealed. One end of small tube extends into the hollow portion of the visor with the other end of the tube removably attached to the open face portion of the visor, thereby allowing the user to hold the open end of the flexible tube in his mouth. The visor is particularly useful for motorcycle riders by allowing the user to keep his mouth moist without taking his hands off the controls. The water will not leak from the visor since it is sealed and must be drawn out by the user.

Hosaka, U.S. Pat. No. 5,148,950, discloses a helmet structure including a separably movable fluid pouch mounted within the helmet below the forward helmet shell opening. The device includes an “L” shaped conduit directed upwardly and mounted medially to a respective right and left fluid cavity of the reservoir structure. The device utilizes hook and loop fastener tabs mounted to a forward surface of the right and left reservoirs for mounting to an interior fibrous surface of the helmet shell. A modification of the invention includes a storage tank mounted to the handle bar structure of an associated motorcycle or bicycle construction utilizing a storage tank conduit hose in communication with a valve mounted to the storage tank to direct fluid to the right and left reservoir pouches.

In each of the above-referenced prior art patents directed to helmet-mounted hydration systems, specialized helmet configurations are required in order to use the helmet in combination with a hydration conduit. Another drawback is that devices that store water in the helmet significantly increase the weight of the helmet. The weight increases the rider's fatigue and decreases his overall performance. Thus, it would be highly desirable to provide an apparatus to be used in combination with a backpack type hydration delivery system which would allow hydration delivery system to be used universally with any type of full face helmet without permanent modification of the helmet itself in order to utilize the helmet to effectively position a hydration conduit.

### SUMMARY OF THE INVENTION

Accordingly, it is an objective of the instant invention to provide an apparatus adapted for universal attachment to a full face helmet which can be used in combination with a backpack-type hydration delivery system to position a hydration tube proximate the mouth of a wearer.

It is a further objective of the instant invention to provide a hydration tube positioning apparatus for a helmet which allows a degree of vertical displacement of the tube within the device.

It is yet another objective of the instant invention to provide a hydration tube positioning apparatus for helmet which is entirely constructed from flexible materials for optimum safety.

It is a further objective of the present invention to provide a hydration tube positioning apparatus for a helmet which can be easily attached and removed from a helmet, without the need for permanent modification of the helmet.

It is a still further objective of the invention to provide a hydration tube positioning apparatus for a helmet which includes an integral air filter which can accommodate the hydration tube.

It is a still further objective of the invention to provide a hydration tube positioning apparatus for a helmet which serves to keep the bite-valve clean and away from dust and debris.

In accordance with the above objectives, an apparatus is provided for attachment to the face protector of a full-face helmet which positions the end of a flexible hydration tube near the mouth of the wearer. The apparatus can comprise an elongated member having a longitudinal elongated slot therein for placement in a perpendicular arrangement with the face protector. The slot has upper and lower ends and dimensioned to allow the hydration tube to be slidably disposed therein, with the upper end having a wider width than the lower end. Left and right opposing portions extend outwardly from the elongated member in a symmetrical arrangement which are configured to align with the face protector. The apparatus includes left and right attachment means disposed on each of said opposing side portions which are operable to secure the opposing side portions to the face protector of the helmet whereby the elongated member can be suspended inside the helmet and the hydration tube inserted in the slot. The elongated member and opposing side portions can be formed as a unitary piece comprising a flexible substantially flat T-shaped member formed from a water-repellent shape-retaining material having a central elongated portion and left and right opposing side arm members.

In a preferred embodiment, the attachment means comprises a pair of straps having mated fastening means securable to one another. The mated fastening means comprises mated portions of hook and loop fastening material, mated snap elements, buckle assemblies, etc.

In another embodiment, the apparatus can further comprise an air filter face mask which can either be attached to the flexible T-shaped member or attached directly to the helmet using separate straps. The air filter face mask comprises a portion of semi-rigid fabric having a perimeter symmetrical about a vertical center line. The mask has an upper portion configured to cover the nose and cheekbones of a user and a lower portion configured to cover the mouth, chin and throat of a user wherein the lower portion has a slit therein along the vertical center line defining two elongated flaps. The two elongated flaps can be crossed inwardly and overlapped to conform to the chin and throat of the user. The mask has an aperture therein at a point of intersection of the slit and the upper portion which is sized for insertion of the hydration tube. The mask is attached to the flexible T-shaped member to align the aperture with the upper end of the elongated slot. In use, the elongated flaps can be crossed over the chin and throat of the user to form a cone-shaped air pocket over the user's mouth. The mask is secured in place with the chin strap of the helmet, and the hydration tube can be inserted through the elongated slot and the aperture in the mask. The aperture in the mask can be formed as cut-out flap complementary to the aperture so that the aperture can be selectively sealed with the cut-out flap. The filter requires goggles to be worn to create a proper seal around the user's nose.

Other objects and advantages of this invention will become apparent from the following description taken in conjunction with the accompanying drawings wherein are set forth, by way of illustration and example, certain embodiments of this invention. The drawings constitute a part of this specification and include exemplary embodiments of the present invention and illustrate various objects and features thereof.

### BRIEF DESCRIPTION OF THE FIGURES

FIG. 1 is a front view of the hydration tube positioning apparatus according to a preferred embodiment of the invention;

FIG. 2 is a rear view of the apparatus shown in FIG. 1;

FIG. 3 is a right side view of the apparatus shown in FIG. 1;

FIG. 4 is a rear perspective view of the apparatus attached to the face protector of a full face helmet;

FIG. 5 is an inside view of the helmet with the apparatus attached as in FIG. 4;

FIG. 6 illustrates a front view alternative embodiment of the apparatus including an air filter mask;

FIG. 7 is a rear view of the apparatus shown in FIG. 5;

FIGS. 8A and 8B illustrate the air filter mask with the hydration tube aperture respectively opened and closed; and

FIG. 9 illustrates the apparatus and air filter mask attached to a full face helmet with a hydration tube inserted therethrough as worn by a user.

### DETAILED DESCRIPTION OF THE INVENTION

Although the invention will be described in terms of a specific embodiment, it will be readily apparent to those skilled in this art that various modifications, rearrangements, and substitutions can be made without departing from the spirit of the invention. The scope of the invention is defined by the claims appended hereto.

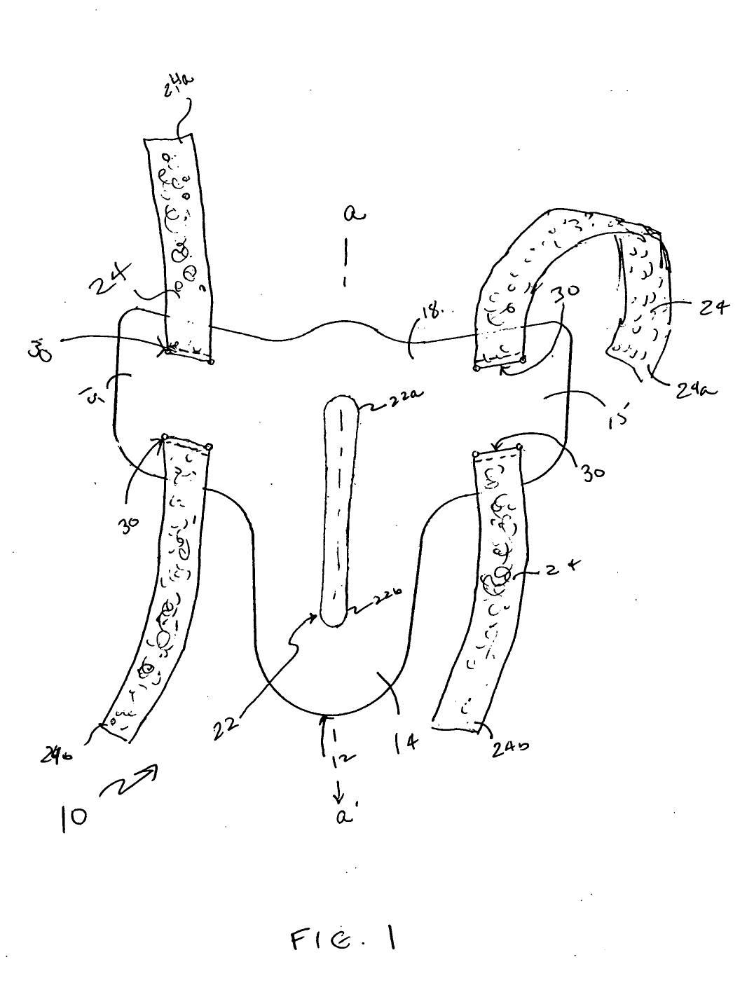

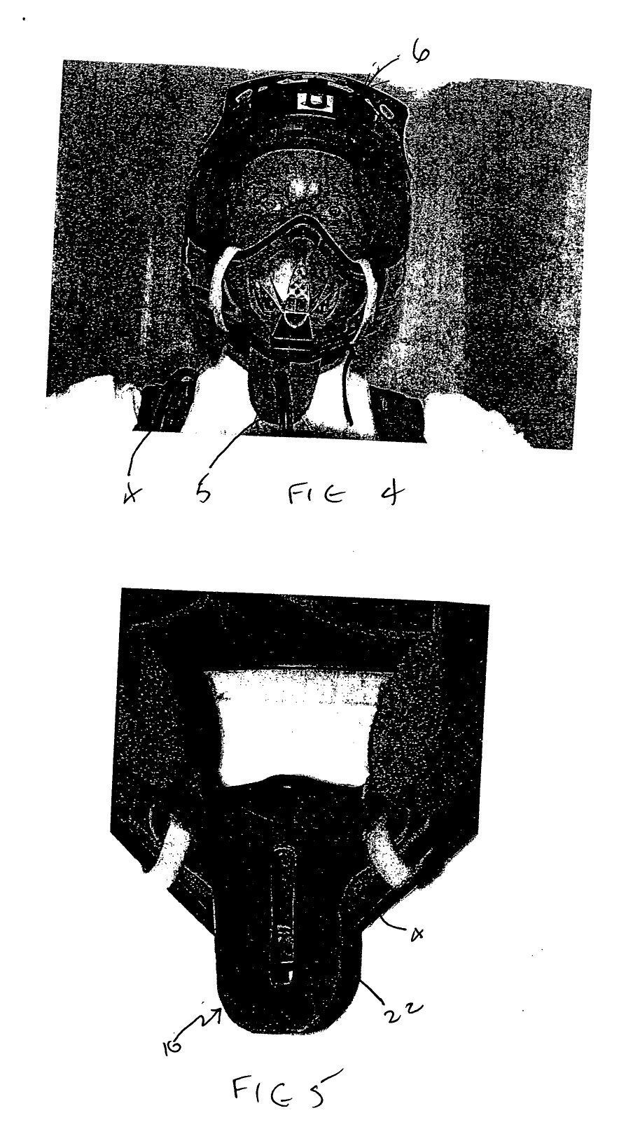

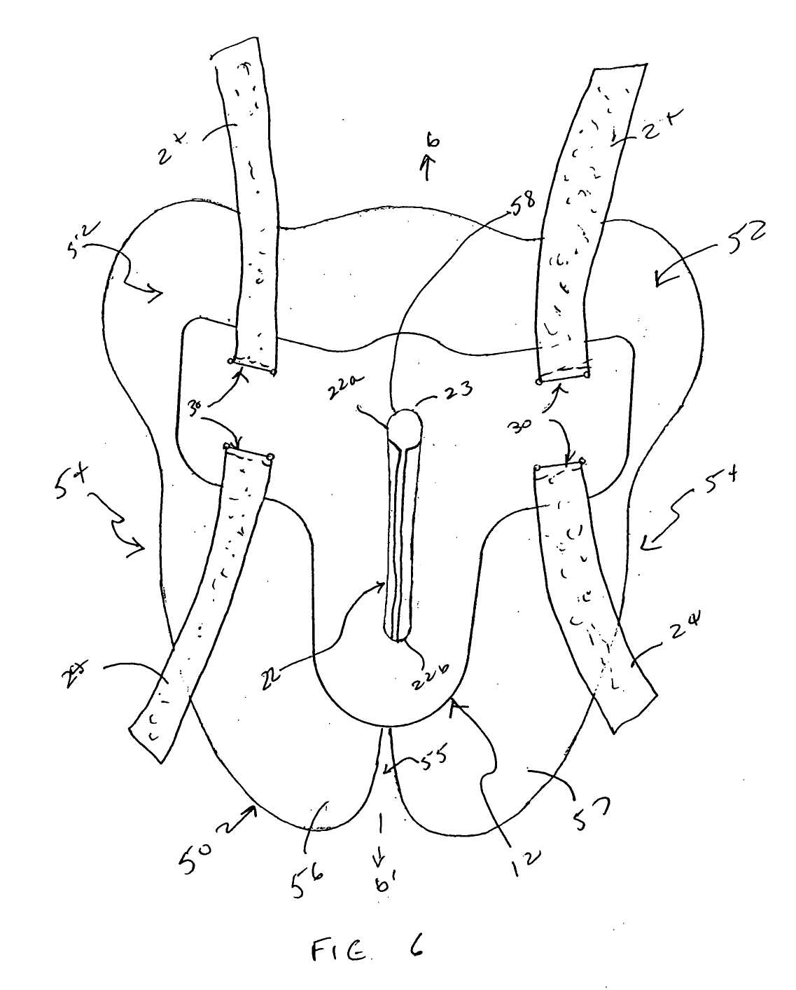

FIGS. 1-3 illustrate a preferred embodiment of the apparatus 10 of the invention which is used in combination with a personal hydration delivery system such as that sold under the trademark Camelbak®. As shown in FIGS. 4 and 5, the device attaches to the face protector 4 of a full-face helmet 6. The apparatus 10 serves to position the hydration tube 5 near the mouth of the wearer to facilitate hand's free use of the hydration tube 5 without the user having to constantly maintain the hydration tube 5 in their mouth.

The apparatus 10 of the invention includes an elongated member having a longitudinal elongated slot therein for placement in a perpendicular arrangement with the face protector. The slot has upper and lower ends and dimensioned to allow the hydration tube to be slidably disposed therein. Left and right opposing portions extend outwardly from the elongated member in a symmetrical arrangement which are configured to align with the face protector. The apparatus includes left and right attachment means disposed on each of said opposing side portions which are operable to secure the opposing side portions to the face protector of the helmet. In this way, the elongated member can be suspended inside the helmet and the hydration tube inserted in the slot.

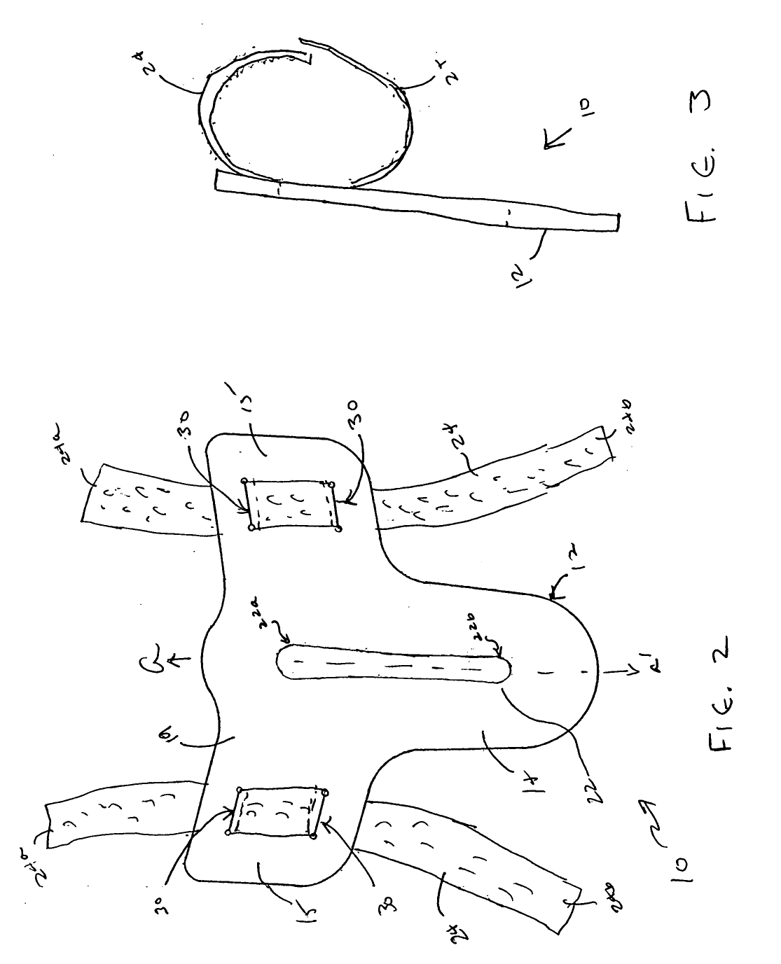

In a preferred embodiment illustrated in FIGS. 1-5, the elongated member and left and right side portions are formed as united piece to provide a flexible, substantially flat T-shaped member 12. The T-shaped member 12 is preferably formed from a water-repellent shape-retaining material, such as rubber or other suitable plastic materials. The material is preferably selected to be sufficiently resilient to satisfy safety considerations. The T-shaped member 12 is preferably symmetrical about a vertical center line a-a′ and has a central elongated portion 14, left and right opposing side arm members 15, 16 and a front side 18 (FIG. 1) and a rear side 19 (FIG. 2). The member 12 is described herein as being T-shaped, however the left and right opposing arm members can be formed with a slight upward arc to conform to the configuration of the helmet face protector.

The central elongated portion 14 of the T-shaped member 12 has an elongated slot 22 along a portion of the vertical center line a-a′. The slot is dimensioned to allow the hydration tube 5 to be slidably disposed therein. In the preferred embodiment, the upper end 22a of the slot 22 is slightly wider than the lower end 22b of the slot 22, with the slot 22 being generally tapered from top to bottom. The lower end 22b is slightly more narrow than the bite valve 6 of the hydration tube 5 so that the bite valve 6 serves to keep the tube 5 within the slot 22. The upper end 22a is wider to accommodate a variety of different types of bite valves 6 and to allow the tube 5 to move easily toward the user's mouth. The T-shape member 12 is constructed from a material which is sufficiently rigid for the slot 22 to hold the tube in place but flexible enough to allow the tube to release should it become caught on something, such as a branch.

The front side 18 of the T-shaped member 12 has left and right attachment means extending therefrom which attach the T-shaped member 12 to the face protector of a helmet. In the preferred embodiment, left and right attachment means are left and right straps 24 which are respectively disposed on each of the opposing side arm members 16. Each of the left and right straps 24 have respective first and second free ends 24a and 24b which are securable to one another. In the illustrated embodiment, one strap is used on each opposing arm member 16, however any number of straps can be utilized in a symmetrical arrangement. Referring again to FIGS. 4 and 5, the left and right straps 24 secure the opposing arm members 15 to the face protector 4 of the helmet 6 so that the flexible T-shaped member 12 is suspended inside the helmet 6 adjacent the lower face of the wearer.

Each of the first and second ends 24a,b of the straps 24 respectively include a mated fastening means so that they can be secured to one another. The fastening means can be mated portions of hook and loop fastening material (such as Velcro®), mated snap elements, buckle assembles, hole and button arrangements, or any other suitable means. It is preferable, however, that the fastening means have a minimum number of metal or hard plastic elements for safety reasons.

The straps 24 can be attached to the flexible T-shaped member using any suitable means which allows the first and second ends 24a,b to be secured to one another. In a preferred embodiment, the flexible T-shaped member 12 can include left and right strap-receiving apertures 30 respectively positioned in the left and right opposing side arm members 15. The left and right strap receiving apertures 30 respectively comprise at least two laterally oriented parallel slots which are vertically aligned. In this arrangement, the left and right straps 24 can each be a single length of strap material which is threaded through the strap receiving apertures 30 so that first and second ends 24a,b extend from the front side 18. As shown in FIGS. 1-4, the left and right straps 24 can each be formed from dual-sided material having textured hook material on a first side and textured loop material on a second side so that the dual-sided straps are self-fastenable in a loop configuration.

The T-shaped member of the apparatus 10 as described above is a unitary piece, however the invention is not limited in that regard. The central elongated member can be formed from any semi-flexible material which includes a at least a portion of semi-rigid material adjacent the elongated slot. For example, the elongated member can be constructed of fabric which includes a rigid reinforcing material attached thereto surrounding the slot. The left and right side portions can also be of suitable configuration and material, and do not to be unitarily formed with the central elongated member. The left and right side portions of the apparatus of the invention need only to conform with the shape of the face protector for ease of attachment.

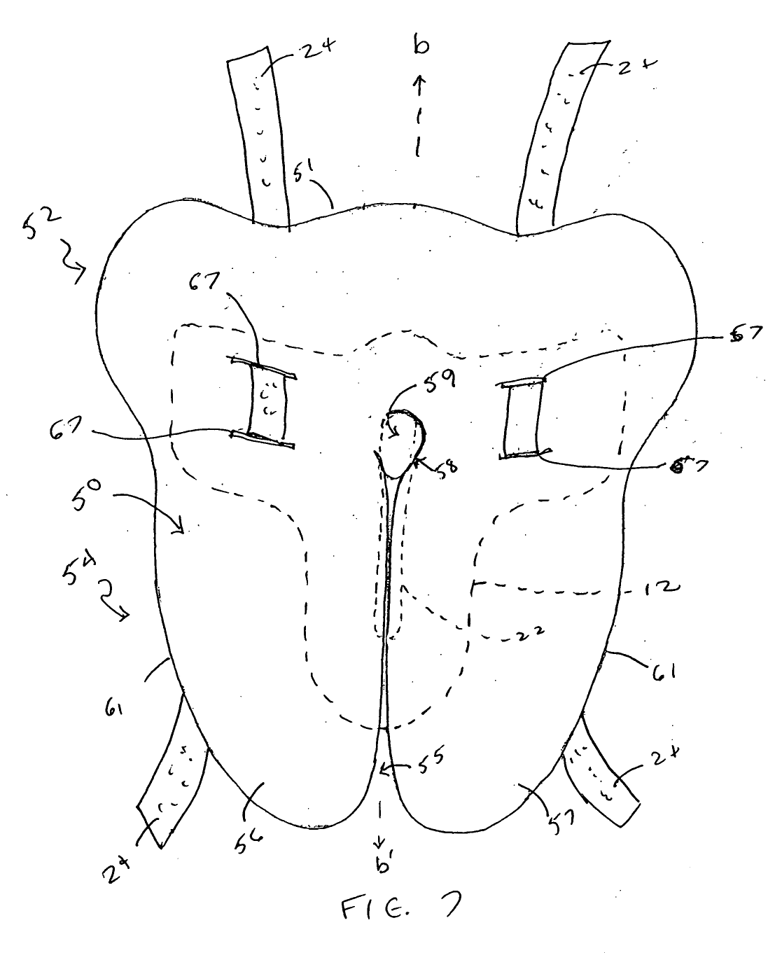

In an alternative embodiment shown in FIGS. 6 and 7, the apparatus 10 of the invention can further include an air filter face mask 50 attachable to the flexible T-shaped member 12. The air filter face mask 50 is constructed from a portion of semi-rigid fabric. Suitable fabrics include a non-woven laminate (such as polypropylene) or a melt-blown composite. The air filter mask 50 has a outer perimeter 61 symmetrical about a vertical center line b-b′, and an upper portion 52 configured to cover the nose and cheekbones of a user and a lower portion 54 configured to cover the mouth, chin and throat of a user. The lower portion 54 has a vertical slit 55 therein along the vertical center line b-b′ which defines two elongated flaps 56,57 which can be crossed inwardly and overlapped to conform to the chin and throat of the user to form a cone-shaped air pocket over the user's mouth and nose. The air filter mask 50 is held in place by the chin strap of the helmet. For an optimum fit, the filter must be tucked between the user's face and the padding of the helmet. Goggles are also required to create a seal around the user's nose. It is preferable that the fabric used for the air filter mask 50 be relatively stiff so that the cone-shaped air pocket does not collapse. The top edge 51 of the outer perimeter 61 can be contoured to provide partial lobes, as shown, so that the air filter mask 50 will conform closely and comfortably to the face of the user.

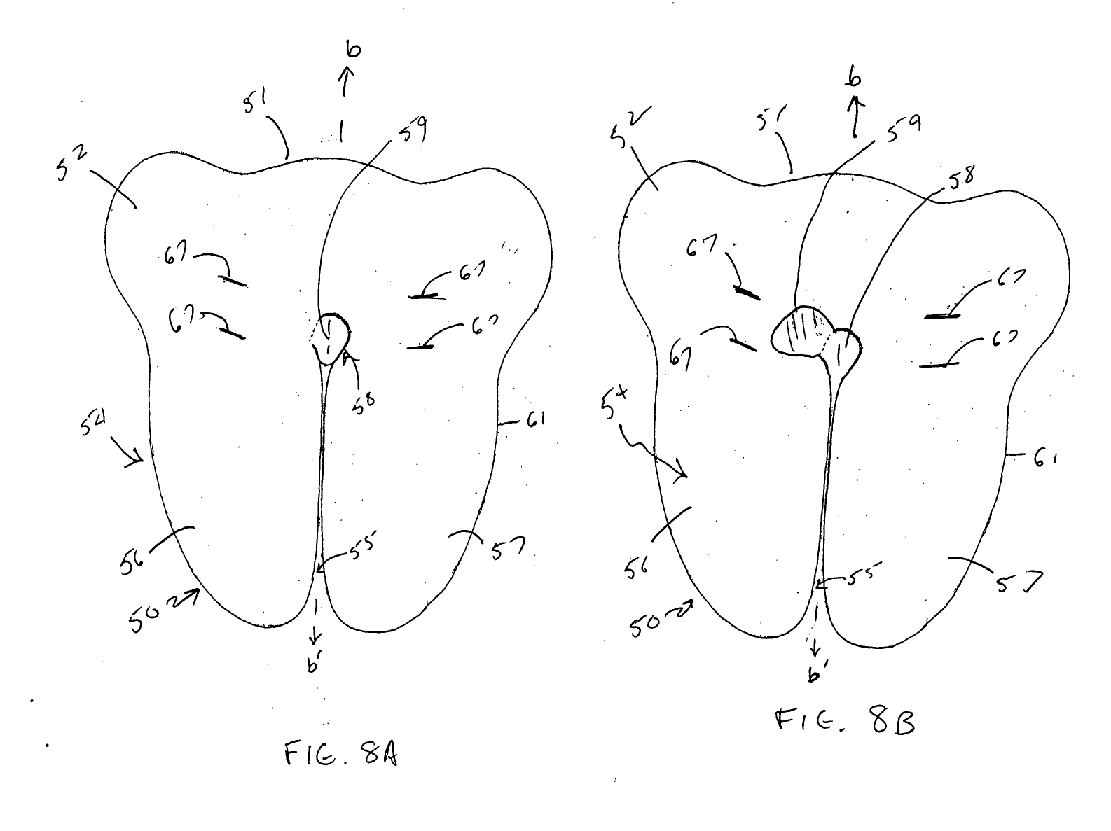

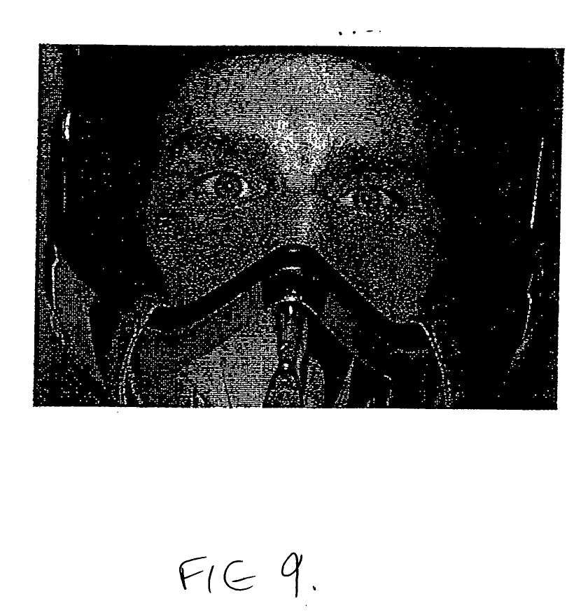

FIGS. 8A and 8B show the air filter mask 50 detached from the flexible T-shaped member 12. As can be best seen in FIG. 8A, the air filter mask 50 has an aperture 58 at the point of intersection of the slit 55 and upper portion which permits the insertion of the hydration tube therethrough. When the air filter mask 50 is attached to the flexible T-shaped member 12, the aperture 58 is aligned with the with the upper end 23 of the elongated slot 22. The aperture 58 in the air filter mask 50 is preferably formed by providing a displaceable cut-out flap 59 complementary to the aperture 58. In this way the aperture 58 can be selectively sealed with the cut-out flap 59 as shown in FIG. 8B. The air filter mask can include a plurality of slits 67 which are positioned to align with the strap receiving apertures 30 in the T-shaped member 12. In this way, the air filter mask 50 can be selectively attached by threading the left and right straps 24 though both the slits 57 in the mask and the strap receiving apertures 30. In an alternative embodiment (not shown) the filter can be attached directly to the helmet using separate straps.

FIG. 9 illustrates the apparatus 10 in use secured to a helmet 5 with the air filter mask 50 worn on the face of the user. The elongated flaps 56,57 are crossed over the chin and throat of the user to form a cone-shaped air pocket over the user's mouth. The mask 50 is secured in place with the chin strap 9 of the helmet 6, and the hydration tube 5 can be inserted through the elongated slot 22 and the aperture 58 in the mask. The air filter mask 50 of the invention can also be used with a cap-type helmet, without the T-shaped member 12, and held in place by the chin strap and goggles worn by the user.

It is to be understood that while a certain form of the invention is illustrated, it is not to be limited to the specific form or arrangement of parts herein described and shown. It will be apparent to those skilled in the art that various changes may be made without departing from the scope of the invention and the invention is not to be considered limited to what is shown and described in the specification and drawings.

I claim:

1. An apparatus adapted for attachment to a face protector of a full-face helmet for positioning an end of a flexible hydration tube near a wearer's mouth, comprising;
an elongated member having a longitudinal elongated slot therein for placement in a perpendicular arrangement with the face protector, said slot having upper and lower ends and dimensioned to allow the hydration tube to be slidably disposed therein;
left and right opposing portions extending therefrom configured to align with the face protector; and
left and right attachment means disposed on each of said opposing side portions, said left and right attachment means operable to secure said opposing side portions to the face protector of the helmet whereby said elongated member can be suspended inside the helmet and the hydration tube inserted in said slot.

2. The apparatus of claim 1, wherein said upper end of said slot has a wider width than said lower end of said slot, said width of said lower end being dimensioned to retain the bite-valve in said slot and said width of said upper end being dimensioned to allow the insertion of the bite-valve therethrough.

3. The apparatus of claim 1, wherein said elongated member further includes a semi-rigid reinforcement means positioned adjacent to said slot and effective for reinforcement thereof.

4. The apparatus of claim 1, wherein said elongated member is formed from a water-repellent shape-retaining material, and said left and right opposing portions are fixedly attached thereto.

5. The apparatus of claim 4, wherein said elongated member and said left and right opposing said members are formed as a unitary piece.

6. The apparatus of claim 4, wherein said unitary piece is formed from a water-repellent shape-retaining material.

7. The apparatus of claim 4, wherein said unitary piece is a substantially flat T-shaped member.

8. The apparatus of claim 1, wherein each of said left and right attachment means are constructed and arranged for removable attachment to said face protector.

9. The apparatus of claim 7, wherein each of said attachment means include first and second free ends which include mated fastening means thereon.

10. An apparatus adapted for attachment to a face protector of a full-face helmet for positioning an end of a flexible hydration tube near a wearer's mouth, comprising;
a flexible substantially flat T-shaped member formed from a water-repellent shape-retaining material, said member being symmetrical about a vertical center line and having a central elongated portion, left and right opposing side arm members, and a front side and a rear side, said flexible T-shaped member having an elongated slot therein positioned along a portion of said vertical center line, said slot having upper and lower ends and dimensioned to allow the hydration tube to be slidably disposed therein; and
left and right attachment means extending from the front side of said T-shaped member respectively disposed on each of said opposing side arm members, said left and right attachment means being operable to secure said opposing arm members to the face protector of the helmet whereby said flexible T-shaped member can be suspended inside the helmet and the hydration tube inserted in said slot.

11. The apparatus of claim 10, wherein said upper end of said slot has a wider width than said lower end of said slot, said width of said lower end being dimensioned to retain the bite-valve in said slot and said width of said upper end being dimensioned to allow the insertion of the bite-valve therethrough.

12. The apparatus of claim 10, wherein each of said left and right attachment means are constructed and arranged for removable attachment to said face protector.

13. The apparatus of claim 10, wherein each of said attachment means include first and second free ends which include mated fastening means thereon.

14. The apparatus of claim 10, further comprising an air filter face mask attachable to said flexible T-shaped member, said filter face mask comprising a portion of semi-rigid fabric having a perimeter symmetrical about a vertical center line, said mask having an upper portion configured to cover the nose and cheekbones of a user and a lower portion configured to cover the mouth, chin and throat of a user wherein said lower portion has a slit therein along said vertical center line defining two elongated flaps which can be crossed inwardly and overlapped to conform to the chin and throat of the user, said mask having an aperture therein at a point of intersection of said slit and upper portion sized for insertion of the hydration tube, and said mask being attached to said flexible T-shaped member to align said aperture with said upper end of said elongated slot;
whereby said elongated flaps can be crossed over the chin and throat of the user to form a cone-shaped air pocket and secured with chin strap padding of the helmet and eye goggles worn by the wearer, and said hydration tube can be inserted through said elongated slot and said aperture.

15. The apparatus of claim 14, wherein said aperture in said mask is formed as displaceable cut-out flap complementary to said aperture, whereby said aperture can be selectively sealed with said cut-out flap.

16. The apparatus of claim 10, wherein said flexible T-shaped member further comprises left and right strap-receiving apertures respectively positioned in said left and right opposing side arm members.

17. The apparatus of claim 16, wherein said left and right strap receiving apertures respectively comprise at least two laterally oriented parallel slots.

18. The apparatus of claim 17, wherein said at least two parallel slots are vertically aligned.

19. The apparatus of claim 18, wherein said left and right attachment means each respectively comprise left and right straps having first and second ends, and said left and right straps are inserted through said at least two parallel slots in said left and right arm members from said rear side of said flexible T-shaped member whereby said first and second ends extend from said front side.

20. The apparatus of claim 19, wherein said first and second ends of said left and right straps each are fastenable to one another.

21. The apparatus of claim 19, wherein said first and second ends of said left and right straps respectively comprise mated portions of hook and loop fastening material.

22. The apparatus of claim 19, wherein said left and right straps each comprise a length of dual-sided material having textured hook material on a first side and textured loop material on a second side whereby said dual-sided straps are self-fastenable in a loop configuration.

23. The apparatus of claim 10, further comprising an air filter face mask attachable to said flexible T-shaped member, said filter face mask comprising a portion of semi-rigid fabric having a perimeter symmetrical about a vertical center line, said mask having an upper portion configured to cover the nose and cheekbones of a user and a lower portion configured to cover the mouth, chin and throat of a user wherein said lower portion has a slit therein along said vertical center line defining two elongated flaps which can be crossed inwardly and overlapped to conform to the chin and throat of the user, said mask having an aperture therein at a point of intersection of said slit and upper portion sized for insertion of a hydration tube, and said mask being attached to said flexible T-shaped member to align said aperture with said upper end of said elongated slot, said mask including left and right pairs of parallel slots alignable with said strap receiving apertures in said T-shaped member, said left and right straps being insertable through said left and right pairs of parallel slots in said mask to secures said mask to said T-shape member, whereby said elongated flaps can be crossed over the chin and throat of the user to form a cone-shaped air pocket and secured with a chin strap of the helmet, and said hydration tube can be inserted through said elongated slot and said aperture.

24. The apparatus of claim 23, wherein said aperture in said mask is formed as a cut-out flap complementary to said aperture, whereby said aperture can be selectively sealed with said cut-out flap.

25. An air filter face mask for use with a helmet having a chin strap and eye protector goggles which is adapted for use with a flexible hydration tube, comprising a portion of semi-rigid fabric having a perimeter symmetrical about a vertical center line, said mask having an upper portion configured to cover the nose and cheekbones of a user and a lower portion configured to cover the mouth, chin and throat of a user wherein said lower portion has a slit therein along said vertical center line defining two elongated flaps which can be crossed inwardly and overlapped to conform to the chin and throat of the user, said mask having an aperture therein at a point of intersection of said slit and upper portion sized for insertion of a hydration tube;
whereby said elongated flaps can be crossed over the chin and throat of the user to form a cone-shaped air pocket and secured with the chin strap padding of the helmet and eye goggles of the wearer, and said hydration tube can be inserted through said aperture.

26. The apparatus of claim 25, wherein said aperture in said mask is formed as cut-out flap complementary to said aperture, whereby said aperture can be selectively sealed with said cut-out flap.
